(19) United States
(12) Patent Application Publication
(10) Pub. No.: US 2018/0359975 A1
(43) Pub. Date: Dec. 20, 2018

(54) SYSTEMS AND METHODS FOR DETERMINING HARVEST TIMING FOR PLANT MATTER WITHIN A GROW POD

(71) Applicant: Grow Solutions Tech LLC, Lehi, UT (US)

(72) Inventors: Gary Bret Millar, Highland, UT (US); Mark Gerald Stott, Eagle Mountain, UT (US); Todd Garrett Tueller, American Fork, UT (US)

(21) Appl. No.: 15/991,614

(22) Filed: May 29, 2018

Related U.S. Application Data
(60) Provisional application No. 62/519,704, filed on Jun. 14, 2017.
(60) Provisional application No. 62/519,701, filed on Jun. 14, 2017.

(51) Int. Cl. A01G 31/04; A01G 9/08; A01D 91/00; G01G 11/04; G01N 5/02; G01N 21/31

(52) U.S. Cl. CPC A01G 31/042; A01G 9/088; A01D 91/00; G01N 2021/8466; G01N 5/02; G01N 21/314; G01G 11/043

(57) ABSTRACT

Systems and methods for determining harvest timing for a cart within an assembly line grow pod include identifying a type of the plant matter positioned within a cart, detecting at least one of a plant matter weight of the plant matter with a weight sensor, a plant matter height of the plant matter with a distance sensor, and a chlorophyll level of the plant matter with a camera, determining that the at least one of the detected plant matter weight, the detected plant matter height, and the detected chlorophyll level satisfies a harvest time parameters, and in response to determining that the detected plant matter weight, the detected plant matter height, and the detected chlorophyll level satisfy the harvest time parameters, directing the cart to a harvester system.

### CROSS REFERENCE TO RELATED APPLICATIONS

This application claims the benefit of U.S. Provisional Application Ser. No. 62/519,704 filed on Jun. 14, 2017 and entitled “Systems and Methods for Managing a Weight of a Plant in a Grow Pod,” and U.S. Provisional Application Ser. No. 62/519,701, filed Jun. 14, 2017 and entitled “Systems and Methods for Determining a Harvest Time For a Grow Pod,” the contents each of which are hereby incorporated by reference in its entirety.

### TECHNICAL FIELD

Embodiments described herein generally relate to systems and methods for determining harvest tinting for plant matter within a grow pod and, more specifically, to determining harvest timing based on a harvest time recipe for the plant matter and detected characteristics of the plant matter.

### BACKGROUND

While crop growth technologies have advanced over the years, there are still many problems in the farming and crop industry. As an example, while technological advances have increased efficiency and production of various crops, many factors may affect a harvest, such as weather, disease, infestation, and the like. Additionally, while the United States currently has suitable farmland to adequately provide food for the U.S. population, other countries and future populations may not have enough farmland to provide the appropriate amount of food.

Controlled environment growing systems may mitigate the factors affecting traditional harvests. Individual plants in controlled environment growing systems may require longer or shorter growing times than other plants within the controlled environment growing system. However, in conventional systems, all of the plants in the growing system may be harvested simultaneously, which may reduce the yield of the growing system. Accordingly, a need exists for improved systems and methods for monitoring the growth of plant matter and determining harvest timing within a controlled environment growing system.

### SUMMARY

In one embodiment, an assembly line grow pod system includes a track, a cart for holding plant matter, the cart engaged with the track, a harvester system positioned at least partially on the track, at least one of a weight sensor positioned on the cart or the track, and a distance sensor, and a controller communicatively coupled to the at least one of the weight sensor and the distance sensor, the controller including a processor and a computer readable and executable instruction set, which when executed, causes the processor to identify a type of the plant matter positioned within the cart, receive data indicative of at least one of a detected plant matter weight from the weight sensor and a detected plant matter height from the distance sensor, retrieve a harvest time recipe based on the identified type of plant matter, the harvest time recipe including a harvest time plant matter weight and a harvest time plant matter height, determine that the at least one of the detected plant matter weight and the detected plant matter height satisfies the harvest time plant matter weight and the harvest time plant matter height, and in response to determining that the at least one of the at least one of the detected plant matter weight and the detected plant matter height satisfies the harvest time plant matter weight and the harvest time plant matter height, direct the cart to the harvester system.

In another embodiment, a method for determining harvest timing for a cart within an assembly line grow pod includes identifying a type of the plant matter positioned within a cart, detecting at least one of a plant matter weight of the plant matter with a weight sensor, a plant matter height of the plant matter with a distance sensor, and a chlorophyll level of the plant matter with a camera, determining that the at least one of the detected plant matter weight, the detected plant matter height, and the detected chlorophyll level satisfies a harvest time plant matter weight, a harvest time plant matter height, and a harvest time plant matter chlorophyll level, and in response to determining that the detected plant matter weight, the detected plant matter height, and the detected chlorophyll level satisfy the harvest time plant matter weight, the harvest time plant matter height, and the harvest time plant matter chlorophyll level, directing the cart to a harvester system.

In yet another embodiment, an assembly line grow pod system includes a track, a cart for holding plant matter, the cart engaged with the track, an actuator positioned on one of the track or the cart, at least one of a weight sensor positioned on the cart or the track, and a distance sensor, and a controller communicatively coupled to the actuator and the at least one of the weight sensor and the distance sensor, the controller including a processor and a computer readable and executable instruction set, which when executed, causes the processor to identify a type of the plant matter positioned within the cart, receive data indicative of at least one of a detected plant matter weight from the weight sensor and a detected plant matter height from the distance sensor, retrieve a harvest time recipe based on the identified type of plant matter, the harvest time recipe including a harvest time plant matter weight and a harvest time plant matter height, determine that the at least one of the detected plant matter weight and the detected plant matter height satisfies the harvest time plant matter weight and the harvest time plant matter height, and in response to determining that the at least one of the detected plant matter weight and the detected plant matter weight satisfies the harvest time plant matter weight and the harvest time plant matter height, move the actuator to an extended position to tilt at least a portion of the cart in a vertical direction.

### BRIEF DESCRIPTION OF THE DRAWINGS

The embodiments set forth in the drawings are illustrative and exemplary in nature and not intended to limit the disclosure. The following detailed description of the illustrative embodiments can be understood when read in conjunction with the following drawings, where like structure is indicated with like reference numerals and in which:

FIG. 1 schematically depicts an assembly line grow pod, according to one or more embodiments shown and described herein;

FIG. 2 schematically depicts a rear perspective view of the assembly line grow pod of FIG. 1, according to one or more embodiments shown and described herein;

FIG. 3A schematically depicts a cart within a harvester of the assembly line grow pod of FIG. 1, according to one or more embodiments shown and described herein;

FIG. 3B schematically depicts the cart within the harvester of FIG. 3A with plant matter being harvested, according to one or more embodiments shown and described herein;

FIG. 3C schematically depicts another cart within the harvester of the assembly line grow pod of FIG. 1, according to one or more embodiments shown and described herein;

FIG. 3D schematically depicts the cart within the harvester of FIG. 3C with plant matter being harvested, according to one or more embodiments shown and described herein;

FIG. 4 schematically depicts a side view of a plurality of carts on a track of the assembly line grow pod of FIG. 1, according to one or more embodiments shown and described herein;

FIG. 5 schematically depicts a computing device for use in the assembly line grow pod of FIG. 1, according to one or more embodiments shown and described herein.

FIG. 6 schematically depicts a flowchart for changing a recipe for plant matter on a cart, according to one or more embodiments shown and described herein; and

FIG. 7 schematically depicts a flowchart for directing a cart to a harvester based on detected plant matter growth, according to one or more embodiments shown and described herein.

### DETAILED DESCRIPTION

Embodiments disclosed herein are directed to assembly line grow pods that selectively direct a cart toward a harvester based on detected characteristics of plant matter within the cart. In embodiments, the assembly line grow pods include a plurality of carts, a sensor configured to measure at least one of a weight, a chlorophyll level, and a height of plant matter in each cart. The plant matter in each cart is identified and data is received from the sensor. A harvest time recipe for the identified plant matter is compared with the received data from the sensor, and each cart is directed toward the harvester to harvest the plant matter or directed to continue moving along the assembly line grow pod to continue growing the plant matter based on the comparison. In this way, harvesting decisions may be made for each individual cart in the assembly line grow pod, which may reduce premature harvesting of plant matter thereby increasing crop yield for the assembly line grow pod. The systems and methods for determining a harvest time for a grow pod incorporating the same will be described in more detail, below.

As used herein, the term “plant matter” may encompass any type of plant and/or seed material at any stage of growth, for example and without limitation, seeds, germinating seeds, vegetative plants, and plants at a reproductive stage.

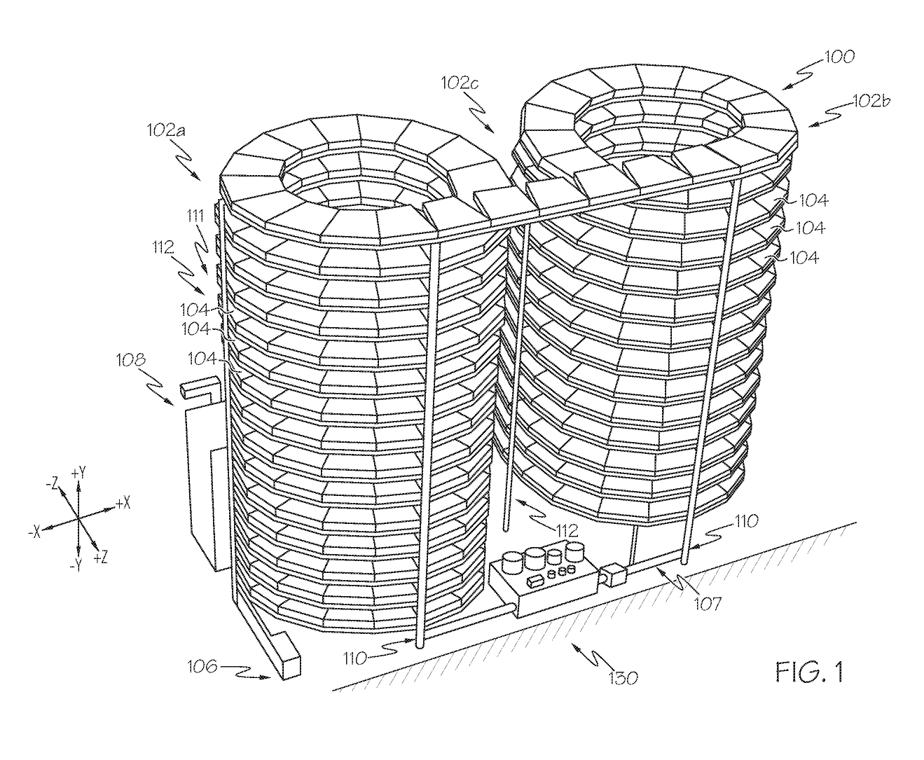

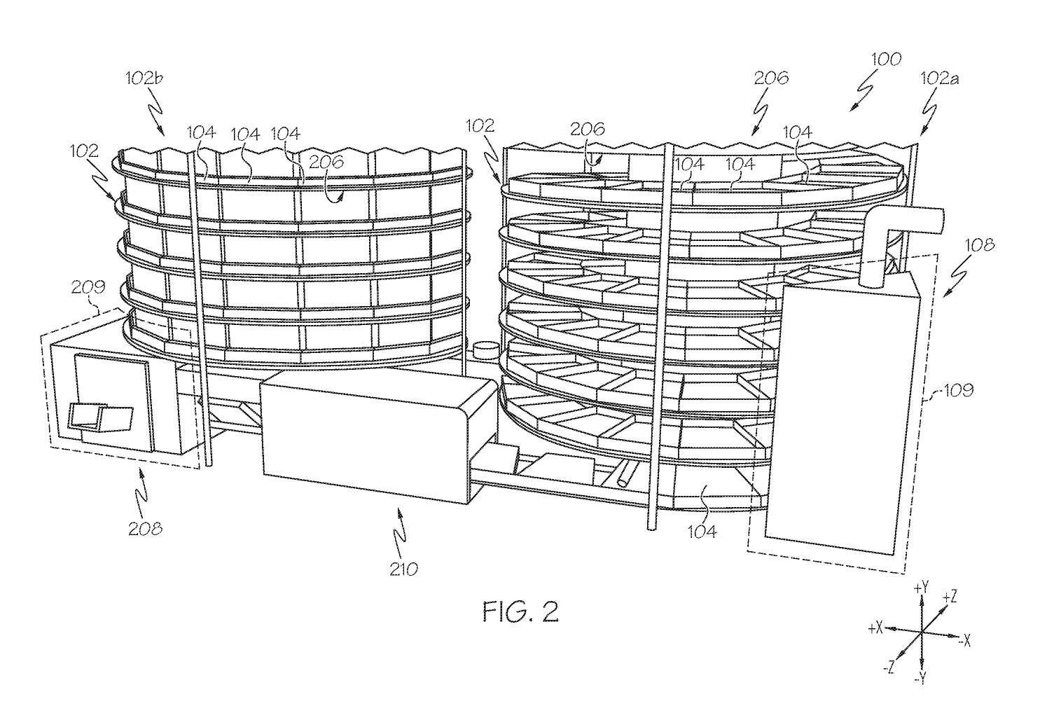

Referring initially to FIGS. 1 and 2, a front perspective view and a rear perspective view of an assembly line grow pod 100 are depicted, respectively. The assembly line grow pod 100 includes a track 102 that is configured to allow one or more carts 104 to travel along the track 102. In the embodiment depicted in FIG. 1, the assembly line grow pod 100 includes an ascending portion 102a, a descending portion 102b, and a connection portion 102c positioned between the ascending portion 102a and the descending portion 102b. The track 102 at the ascending portion 102a moves upward in a vertical direction (i.e., in the +y-direction as depicted in the coordinate axes of FIG. 1), such that carts 104 moving along the track 102 move upward in the vertical direction as they travel along the ascending portion 102a. The track 102 at the ascending portion 102a may include curvature as depicted in FIG. 1, and may wrap around a first axis that is generally parallel to the y-axis depicted in the coordinate axes of FIG. 1, forming a spiral shape around the first axis. The connection portion 102c is positioned between the ascending portion 102a and the descending portion 102b, and may be relatively level as compared to the ascending portion 102a and the descending portion 102b, such that the track 102 generally does not move upward or downward in the vertical direction at the connection portion 102c. The track 102 at the descending portion 102b moves downward in the vertical direction (i.e., in the −y-direction as depicted in the coordinate axes of FIG. 1), such that carts 104 moving along the track 102 move downward in the vertical direction as they travel along descending portion 102b. The track 102 at the descending portion 102b may be curved, and may wrap around a second axis that is generally parallel to the y-axis depicted in the coordinate axes of FIG. 1, forming a spiral shape around the second axis. In some embodiments, such as the embodiment shown in FIG. 1, the ascending portion 102a and the descending portion 102b may generally form symmetric shapes and may be mirror-images of one another, in other embodiments, the ascending portion 102a and the descending portion 102b may include different shapes that ascend and descend in the vertical direction, respectively. The ascending portion 102a and the descending portion 102b may allow the track 102 to extend a relatively long distance while occupying a comparatively small footprint evaluated in the x-direction and the z-direction as depicted in the coordinate axes of FIG. 1, as compared to assembly line grow pods that do not include an ascending portion 102a and a descending portion 102b. Minimizing the footprint of the assembly line grow pod 100 may be advantageous in certain applications, such as when the assembly line grow pod 100 is positioned in a crowded urban center or in other locations in which space is limited.

Referring particularly to FIG. 2, an enlarged rear view of the assembly line grow pod 100 is depicted. In embodiments, the assembly line grow pod 100 generally includes a seeder system 108, a lighting system 206, a harvester system 208, and a sanitizer system 210. In the embodiment depicted in FIG. 2, the seeder system 108 is positioned on the ascending portion 102a of the assembly line grow pod 100 and defines a seeding region 109 of the assembly line grow pod 100. In embodiments, the harvester system 208 is positioned on the descending portion 102b of the assembly line grow pod 100 and defines a harvesting region 209 of the assembly line grow pod 100. In operation, carts 104 may initially pass through the seeding region 109, travel up the ascending portion 102a of the assembly line grow pod 100, down the descending portion 102b, and into the harvesting region 209.

The lighting system 206 includes one or more electromagnetic sources to provide light waves in one or more predetermined wavelengths that may facilitate plant growth. Electromagnetic sources of the lighting system 206 may generally be positioned on the underside of the track 102 such that the electromagnetic sources can illuminate plant matter in the carts 104 on the track 102 below the electromagnetic sources.

The harvester system 208 is configured to harvest plant matter within a cart 104 as described in greater detail herein.

Once the plant matter within the cart 104 is harvested by the harvester system 208, the carts 104 move to the sanitizer system 210. The sanitizer system 210 is configured to remove the plant matter and/or other particulate matter remaining on the carts 104. The sanitizer system 210 may include any one or combination of different washing mechanisms, and may apply high pressure water, high temperature water, and/or other solutions for cleaning the cart 104 as the cart 104 passes through the sanitizer system 210. Once the remaining particulate and/or plant matter is removed in the carts 104, the cart 104 moves into the seeding region 109, where the seeder system 108 deposits seeds within the cart 104 for a subsequent growing process.

Referring particularly to FIG. 1, in embodiments, the assembly line grow pod 100 includes a watering system 107 and an airflow system 111. The watering system 107 generally includes one or more water lines 110, which distribute water and/or nutrients to carts 104 at predetermined areas of the assembly line grow pod 100. For example, in the embodiment depicted in FIG. 1, the one or more water lines 110 extend up the ascending portion 102a and the descending portion 102b (e.g., generally in the +/−y-direction of the coordinate axes of FIG. 1) to distribute water and nutrients to plant matter within carts 104 on the track 102. The airflow system 111, as depicted in FIG. 1, includes one or more airflow lines 112 that extend throughout the assembly line grow pod 100. For example, the one or more airflow lines 112 may extend up the ascending portion 102a and the descending portion 102b (e.g., generally in the +/−y-direction of the coordinate axes of FIG. 1) to ensure appropriate airflow to plant matter positioned within the carts 104 on the track 102 of the assembly line grow pod 100. The airflow system 111 may assist in maintaining plant matter within the carts 104 on the track at an appropriate temperature and pressure, and may assist in maintaining appropriate levels of atmospheric gases within the assembly line grow pod 100 (e.g., carbon dioxide, oxygen, and nitrogen levels).

Referring again to FIG. 2, the harvester system 208 generally includes mechanisms suitable for removing and harvesting plant matter from carts 104 positioned on the track 102. For example, the harvester system 208 may include one or more blades, separators, or the like configured to harvest plant matter. In some embodiments, when a cart 104 enters the harvesting region 209, the harvester system 208 may cut plant matter within the cart 104 at a predetermined height. In some embodiments, the harvester system 208 may be configured to automatically separate fruit from plant matter within a cart 104, such as via shaking, combing, etc. If the remaining plant matter may be reused, plant matter remaining on the cart 104 after harvesting may remain on the cart 104 as the cart 104 to be reused in a subsequent growing process. If the plant matter is not to be reused, the plant matter within the cart 104 may be removed from the cart 104 for processing, disposal, or the like.

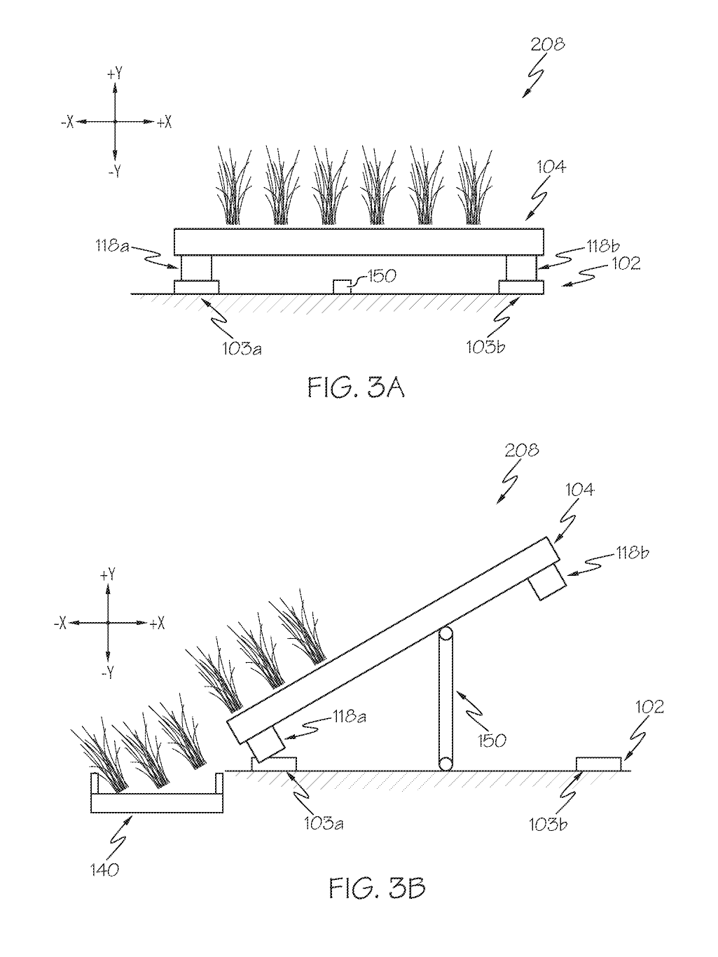

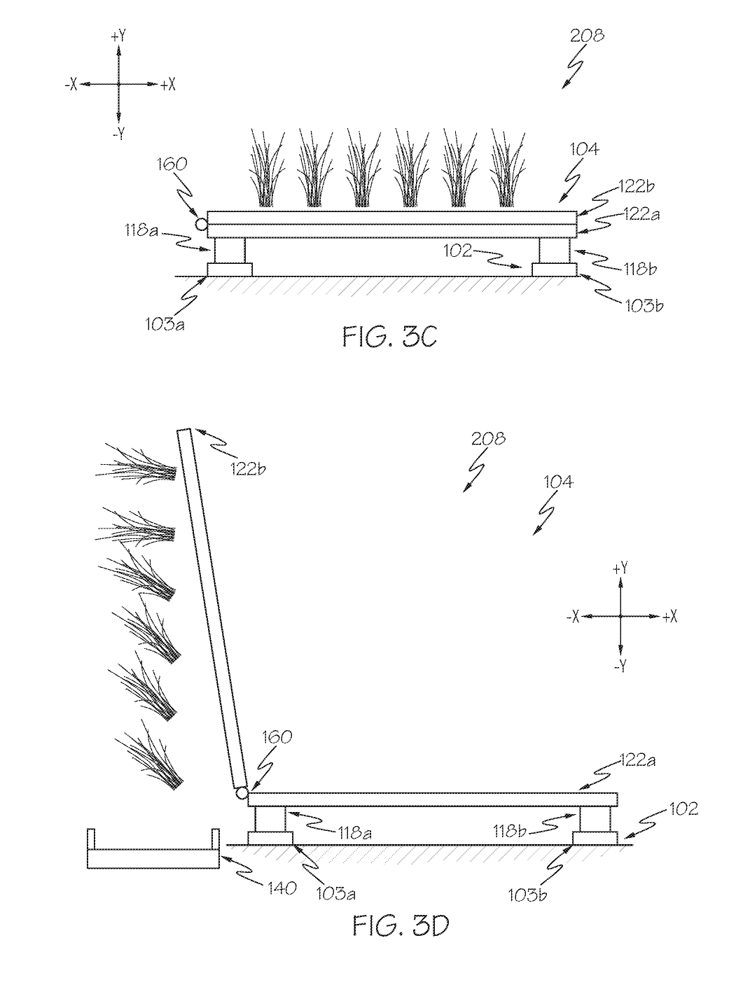

Referring now to FIGS. 3A and 3B, the carts 104 are depicted within the harvester system 208 during a harvesting process. Referring first to FIG. 3A, one cart 104 holding plant matter is depicted moving along the track 102. In the embodiment depicted in FIG. 3A, the track 102 includes opposing rails 103a and 103b. The cart 104 may include wheels 118a and 118b that are engaged with the rails 103a and 103b of the track, respectively.

Referring to FIG. 3B, the harvester system 208 includes an actuator 150 positioned to push up the cart 104 such that the wheel 118b is lifted off from the rail 103b. The actuator 150 is repositionable between an extended position, in which the actuator 150 engages the cart 104 as shown in FIG. 3B, and a retracted position, in which the actuator 150 is disengaged from the cart 104 as shown in FIG. 3A. In the extended position, the actuator tilts the cart 104 in the vertical direction (e.g., in the y-direction as depicted in the coordinate axes of FIG. 3B) such that the plant matter within the cart 104 is dumped out of the cart 104. While FIG. 3B illustrates that the actuator 150 is placed under the cart 104, the actuator may be in any suitable position to tilt the cart 104. For example, an actuator may engage one side of the cart 104, as opposed to the bottom of the cart 104 as shown in FIG. 3B, and may raise the side of the cart 104 such that the cart 104 is tilted.

The harvester system 208 further includes a collecting apparatus 140 to collect the harvested plant matter that has been dumped from the cart 104. In embodiments, the collecting apparatus 140 includes a conveyor belt or the like configured to move the harvested plant matter out of the harvester system 208. In such embodiments, the collecting apparatus 140 may move the harvested plant matter to a collection receptacle or the like for further processing, such as by chopping, mashing, juicing, or the like. In other embodiments, the collecting apparatus 140 may simply include a receptacle for collecting the harvested plant matter. The plant matter, in some configurations, may be grown without the use of soil, such as through a hydroponic process or the like. In these configurations, the plant matter may not generally require washing or processing to remove soil from the plant matter. Additionally, the roots of the plant matter may grow to be intertwined such that the plant matter may be removed from the cart 104 as a single lump, in some configurations.

Referring to FIG. 3C, the cart 104 itself may include an actuator 160 in another embodiment. In the embodiment depicted in FIG. 3C, the cart 104 includes a lower plate 122a, an upper plate 122b positioned above the lower plate 122a, and the actuator 160 positioned between the lower plate 122a and the upper plate 122b, The upper plate 122b and the lower plate 122a, are hingedly coupled at the actuator 160 such that the upper plate 122b is rotatable with respect to the lower plate 122a about the actuator 160. While the embodiment depicted in FIG. 3C includes the lower plate 122a, it should be understood that the lower plate 122a may optionally be omitted, and the upper plate 122b may rotate with respect to the wheels 118a, 118b about the actuator 160.

The actuator 160 is repositionable between an extended position in which the upper plate 122b is tilted with respect to the lower plate 122a as shown in FIG. 3D, and a retracted position in which the upper plate 122b is generally in-plane with the lower plate 122a as shown in FIG. 3C. In this manner, the upper plate 122b may be selectively tilted in the vertical direction (e.g., in the y-direction as depicted in the coordinate axes of FIG. 3D) to dump plant matter from the cart 104. In embodiments, the actuator may be an electric motor or the like configured to rotate the upper plate 122b about the actuator 160.

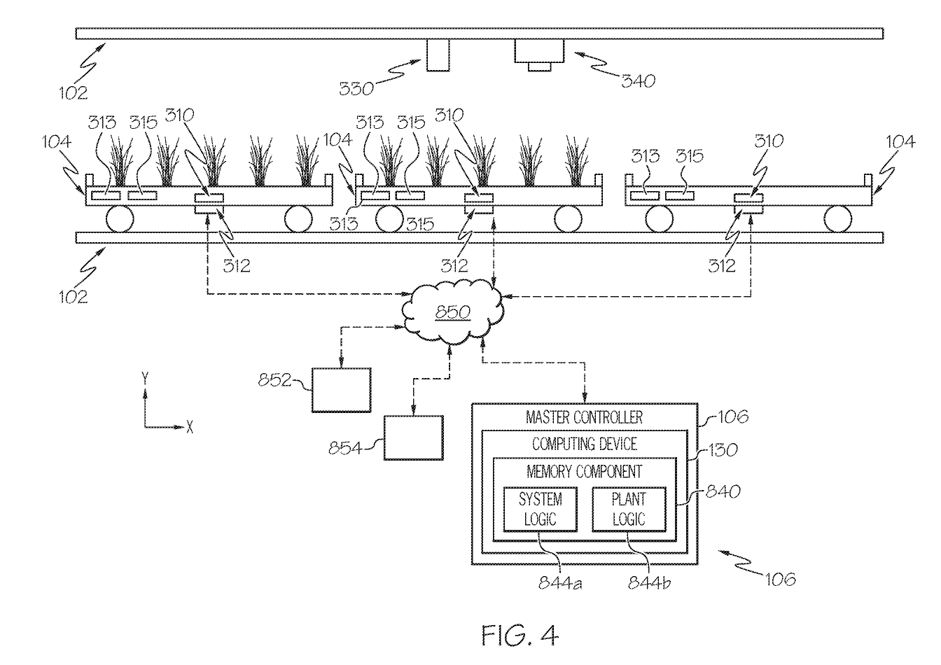

Referring to FIG. 4, at positions outside of the harvesting region 209 (FIG. 2) the assembly line grow pod 100 includes one or more distance sensors 330, one or more cameras 340, and weight sensors 310 positioned on the carts 104 to detect growth of plant matter to determine whether harvesting is appropriate. In embodiments, the assembly line grow pod 100 further includes a master controller 106 that is communicatively coupled to one or more of the seeder system 108 (FIG. 2), the harvester system 208 (FIG. 2), the sanitizer system 210 (FIG. 2), the watering system 107 (FIG. 1), the lighting system 206 (FIG. 2), and the airflow system 111 (FIG. 1). In some embodiments, the master controller 106 may also be communicatively coupled to the one or more distance sensors 330, the one or more cameras 340, and the weight sensors 310, as described in greater detail herein.

The carts 104 include the weight sensors 310 are configured to measure the weight of a payload on the carts 104, such as plant matter. The carts 104 also include cart computing devices 312 that are communicatively coupled to the weight sensors 310. The cart computing devices 312 may have wireless network interface for communicating with the master controller 106 through a network 850. In some embodiments, each of the carts 104 may include a plurality of weight sensors positioned at different locations throughout the cart 104 to detect the weight of plant matter positioned at different locations within the cart 104,

In some embodiments, a plurality of weight sensors may be placed on the track 102. The weight sensors are configured to measure the weights of the carts on the track 102 and transmit the weights to the master controller 106. The master controller 106 may determine the weight of plants on a cart by subtracting the weight of the cart from the weight received from the weight sensors on the track 102.

Still referring to FIG. 4, the carts 104 may optionally include additional sensors, such as environmental sensors 313 and position sensors 315, in embodiments. Each environmental sensor 313 may include one or more sensors configured to detect moisture within the cart 104, a water level within the cart 104 (such as when the assembly line grow pod 100 utilizes a hydroponic growing process), or the like. The amount of water within the cart 104 may affect the weight detected by the weight sensors 311 and the weight sensors 310. Accordingly, understanding the amount of water within a cart 104, as indicated by a water level within the cart 104, may be useful in determining the weight of plant matter within the cart 104 as detected by the weight sensors 311 and the weight sensors 310. The environmental sensors 313 are communicatively coupled to cart computing devices 312 and may send signals indicative of the growing environment of the cart 104. The position sensors 315 may include one or more sensors configured to detect a position and/or a speed of the cart 104, such as a global positioning sensor or the like. The position sensors 315 are communicatively coupled to the cart computing devices 312, and may send signals indicative of the position of the cart 104 within the assembly line grow pod 100 and/or the speed at which the cart 104 is moving within the assembly line grow pod 100. The position and the speed of travel of the cart 104 within the assembly line grow pod 100 may be indicative of the elapsed time in which the cart 104 has been growing plant matter within the assembly line grow pod 100, and accordingly, may be used to monitor the progress of the growth of plant matter within the cart 104. Additionally, in some embodiments, the position sensors 315 may detect when the cart is at different positions on the track 102, and the weight sensors 310 may detect the weight of plant matter in the cart 104 at the different positions on the track 102. For example, a position sensor 315 may detect When the cart 104 is at a first position on the track 102, such as at the ascending portion 102a (FIG. 1), and the weight sensor and/or weight sensors 310 may detect the weight of the plant matter in the cart at the first position. The position sensor 315 may detect when the cart is at a second position on the track that is downstream of the first position, such as at the descending portion 102b (FIG. 1), and the weight sensor and/or weight sensors 310 may detect the weight of the plant matter in the cart at the second position. By comparing the detected weight of the plant matter at the first position and the second position, growth of plant matter in a particular cart 104 may be monitored.

In the embodiment depicted in FIG. 4, the assembly line grow pod 100 includes the distance sensor 330 positioned over the carts 104. In embodiments, the distance sensor 330 may be attached to an underside of the track 102, such that the distance sensor 330 is positioned between levels of the track 102. The distance sensor 330 may be configured to detect a distance between the distance sensor 330 and the plant matter within the carts 104. For example, the distance sensor 330 include any one or more sensors configured to detect distance, such as a laser sensor, a proximity sensor, or the like, and may transmit electromagnetic waves and receive waves reflected from the plant matter within the carts 104. Based on the travelling time of the electromagnetic waves, the distance sensor 330 may determine the distance between the distance sensor 330 and the plant matter within the carts 104. The dimensions of the carts 104 and the position of the distance sensor 330 with respect to the carts 104 may be generally constant, and accordingly, a detected distance between the distance sensor 330 and plant matter within a cart 104 may be indicative of a height of the plant matter.

The assembly line grow pod 100 may further include a camera 340 or other image capture device may be positioned on an underside of the track 102 over the carts 104. The camera 340 may be configured to capture an image of the plants in the carts 104. The camera 340 may have a wider angle lens to capture plants of more than one of the carts 104. For example, the camera 340 may capture the images of the plants in the carts 104 depicted in FIG. 4. The camera 340 may include a special filter that filters out artificial LED lights from lighting devices in the assembly line grow pod 100 such that the camera 340 may capture the natural colors of the plants.

Harvest timing for the plant matter may be determined by comparing data from weight sensors 310, the distance sensor 330, and/or the camera 340 with a harvest time recipe for the plants. The harvest time recipe may include information about plants that are to be harvested. For example, Table 1 below shows example harvest time recipes for various plants.

TABLE 1

| | | | Chlorophyll |
|---|---|---|---|
| | Plant Matter Weight | Plant Matter Height | Level |
| Plant Matter A | 60 pounds | 10 inches | 20 |
| Plant Matter B | 100 pounds | 15 inches | 30 |
| Plant Matter C | 120 pounds | 17 inches | 35 |
| Plant Matter D | 70 pounds | 12 inches | 20 |

The chlorophyll level may be a value in the scale of 0 to 100 that is converted from a processed image. For example, the chlorophyll level may be based on a color level detected from an image taken by the camera 340. In some embodiments, the harvest time recipe may include any other parameters related to growth of plants, such as a size of a fruit, a color of the fruit, a level of nutrients, for example, protein, carbohydrates, sugar content, etc.

In one example, the master controller 106 may identify a type of plant matter within a cart 104 as being of “Type A” as shown in Table 1 above. For example, a user may input the plant matter type into a user computing device 852 of the master controller 106. In some embodiments, the plant matter type may be identified automatically, such as by an image taken from the camera 340. The master controller 106 may then compare a detected weight of the plant matter on the cart 104 with the weight sensor 310 with the plant matter weight of the harvest time recipe for type A plant matter (e.g., 60 pounds). Similarly, the master controller 106 may compare a detected plant matter height from the distance sensor 330 with the plant matter height of the harvest time recipe for type A plant matter (e.g., 10 inches). The master controller 106 may also compare a detected chlorophyll level from the camera 340 with the chlorophyll level of the harvest time recipe for type A plant matter (e.g., 20). If the detected values for plant matter weight, plant matter height, and/or chlorophyll level satisfy the harvest time recipe parameters for plant matter weight, plant matter height, and/or chlorophyll level, the master controller 106 may determine that the plant matter within the cart 104 is ready for harvest. Based on the determination whether the plant matter within the cart 104 is ready for harvest, the master controller 106 may direct the cart 104 to the harvester system 208 (FIG. 2) for harvesting. Alternatively, the master controller 106 may direct the cart 104 to take another lap around the assembly line grow pod 100 (e.g., up the ascending portion 102a and down the descending portion 102b as shown in FIG. 1) in response to determining that the plant matter within the cart 104 is not ready for harvest. For example, the master controller 106 may be communicatively coupled to one or more track switches that may selectively direct a cart 104 to the harvester system 208 (FIG. 2) or to the ascending portion 102a (FIG. 1). The master controller 106 may additionally or alternatively change a nutrition recipe to be dispensed to the plant matter on the cart 104 in response to determining whether the plant matter is ready for harvest. For example, the master controller 106 may increase or decrease a level of water and/or nutrients provided to the plant matter on the cart 104 by the watering system 107 (FIG. 1), may increase or decrease a level of light provided by the lighting system 206 (FIG. 2), and/or may increase or decrease airflow provided by the airflow system 111 (FIG. 1) to either facilitate additional plant growth (e.g., if the plant matter is not ready for harvest) to maintain the present level of plant growth (e.g., if the plant matter is ready for harvest).

The harvest time recipes may be stored in the plant logic 844b, and the master controller 106 may retrieve the harvest time recipes from the plant logic 844b. In some embodiments, the master controller 106 may receive the harvest time recipes from an operator through the user computing device 852. For example, an operator may input a desired weight, height, chlorophyll level, and/or any other parameters related to the growth of plants for harvesting through the user computing device 852.

Still referring to FIG. 4, the master controller 106 may include a computing device 130. The computing device 130 may include a memory component 840, which stores systems logic 844a and plant logic 844b. As described in more detail below, the systems logic 844a may monitor and control operations of one or more of the components of the assembly line grow pod 100. For example, the systems logic 844a may monitor and control operations of the light devices, the water distribution component, the nutrient distribution component, the air distribution component. The plant logic 844b may be configured to determine and/or receive a recipe for plant growth and may facilitate implementation of the recipe via the systems logic 844a.

Additionally, the master controller 106 is coupled to a network 850. The network 850 may include the internet or other wide area network, a local network, such as a local area network, a near field network, such as Bluetooth or a near field communication (NFC) network. The network 850 is also coupled to a user computing device 852 and/or a remote computing device 854. The user computing device 852 may include a personal computer, laptop, mobile device, tablet, server, etc. and may be utilized as an interface with a user. As an example, the total weight of seeds in each of the carts may be transmitted to the user computing device, and a display of the user computing device 852 may display the weight for each of the carts.

Similarly, the remote computing device 854 may include a server, personal computer, tablet, mobile device, etc. and may be utilized for machine to machine communications. As an example, if the master controller 106 determines a type of seeds being used (and/or other information, such as ambient conditions), the master controller 106 may communicate with the remote computing device 854 to retrieve a previously stored recipe for those conditions. As such, some embodiments may utilize an application program interface (API) to facilitate this or other computer-to-computer communications.

In some embodiments, for each of the carts 104 on the track 102, the master controller 106 may initiate harvesting process based on data received from at least one of the weight sensors 310, the distance sensor 330, and the camera 340. The master controller 106 may instruct an actuator to tilt the cart that carries plants to be harvested such that the plants are dumped out from the cart.

The master controller 106 may include a computing device 130. The computing device 130 may include a memory component 840, which stores systems logic 844a and plant logic 844b. As described in more detail below, the systems logic 844a may monitor and control operations of one or more of the components of the assembly line grow pod 100. For example, the systems logic 844a may monitor and control operations of the lighting system 206 (FIG. 2), the watering system 107, the airflow system 111, the harvester system 208 (FIG. 2), the sanitizer system 210 (FIG. 2), and the seeder system 108. The plant logic 844b may be configured to determine and/or receive a stored recipe for plant growth and may facilitate implementation of the recipe via the systems logic 844a. In some embodiments, detected weights of plant matter may be stored in the plant logic 844b to determine trends in the detected weight of the plant matter, and the determined or stored recipe for plant growth may be based at least in part on the determined trend. For example, if the determined trend based on detected weights of plant matter indicates that the plant matter is consistently below a desired plant weight, the stored recipe for that particular type of plant matter may be changed to increase plant growth in future grow cycles.

The master controller 106 is coupled to a network 850. The network 850 may include the internet or other wide area network, a local network, such as a local area network, a near field network, such as Bluetooth or a near field communication (NFC) network. The network 850 is also coupled to a user computing device 852 and/or a remote computing device 854. The user computing device 852 may include a personal computer, laptop, mobile device, tablet, phablet, mobile device, or the like and may be utilized as an interface with a user. As an example, a detected weight of plant matter within each of the carts 104 may be transmitted to the user computing device 852, and a display of the user computing device 852 may display the weight for each of the carts. The user computing device 852 may also receive input from a user, for example, the user computing device 852 may receive an input indicative of a type of seeds to be placed in the carts 104 by the seeder system 108.

Similarly, the remote computing device 854 may include a server, personal computer, tablet, phablet, mobile device, server, or the like, and may be utilized for machine to machine communications. As an example, if the master controller 106 determines a type of seeds being used (and/or other information, such as ambient conditions), the master controller 106 may communicate with the remote computing device 854 to retrieve a previously stored recipe (e.g., predetermined preferred growing conditions, such as water/nutrient requirements, lighting requirements, temperature requirements, humidity requirements, or the like). As such, some embodiments may utilize an application program interface (API) to facilitate this or other computer-to-computer communications.

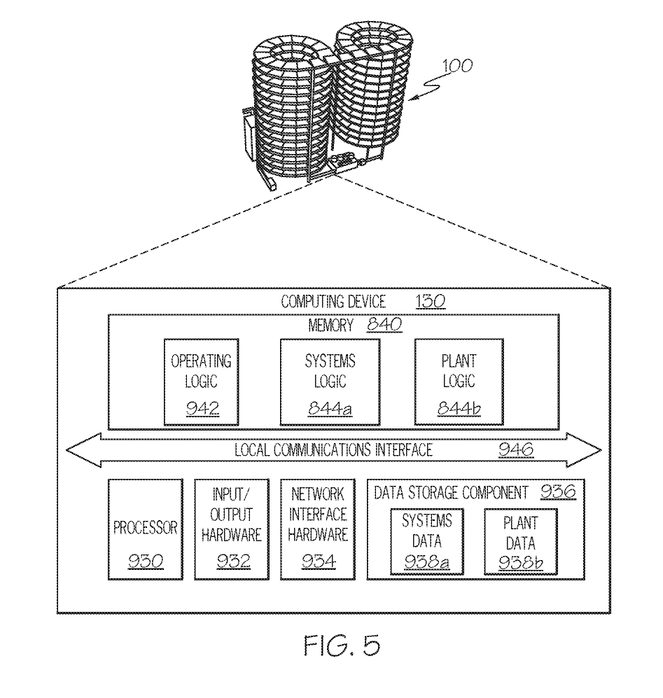

FIG. 5 depicts the computing device 130 of the master controller 106, according to embodiments described herein. As illustrated, the computing device 130 includes a processor 930, input/output hardware 932, the network interface hardware 934, a data storage component 936 (which stores systems data 938a, plant data 938b, and/or other data), and the memory component 840. The memory component 840 may be configured as volatile and/or nonvolatile memory and as such, may include random access memory (including SRAM, DRAM, and/or other types of RAM), flash memory, secure digital (SD) memory, registers, compact discs (CD), digital versatile discs (DVD), bernoulli cartridges, and/or other types of non-transitory computer-readable mediums. Depending on the particular embodiment, these non-transitory computer-readable mediums may reside within the computing device 130 and/or external to the computing device 130.

The memory component 840 may store operating logic 942, the systems logic 844a, and the plant logic 844b. The systems logic 844a and the plant logic 844b may each include a plurality of different pieces of logic, each of which may be embodied as a computer program, firmware, and/or hardware, as an example. The computing device 130 further includes a local interface 946 that may be implemented as a bus or other communication interface to facilitate communication among the components of the computing device 130.

The processor 930 may include any processing component operable to receive and execute instructions (such as from a data storage component 936 and/or the memory component 840). The input/output hardware 932 may include and/or be configured to interface with microphones, speakers, a display, and/or other hardware.

The network interface hardware 934 may include and/or be configured for communicating with any wired or wireless networking hardware, including an antenna, a modem, LAN port, wireless fidelity (Wi-Fi) card, WiMax card, ZigBee card, Bluetooth chip, USB card, mobile communications hardware, and/or other hardware for communicating with other networks and/or devices. From this connection, communication may be facilitated between the computing device 130 and other computing devices, such as the user computing device 852 and/or remote computing device 854.

The operating logic 942 may include an operating system and/or other software for managing components of the computing device 130. As also discussed above, systems logic 844a and the plant logic 844b may reside in the memory component 840 and may be configured to perform the functionality, as described herein.

It should be understood that while the components in FIG. 5 are illustrated as residing within the computing device 130, this is merely an example. In some embodiments, one or more of the components may reside external to the computing device 130. It should also be understood that, while the computing device 130 is illustrated as a single device, this is also merely an example. In some embodiments, the systems logic 844a and the plant logic 844b may reside on different computing devices. As an example, one or more of the functionalities and/or components described herein may be provided by the user computing device 852 and/or remote computing device 854.

Additionally, while the computing device 130 is illustrated with the systems logic 844a and the plant logic 844b as separate logical components, this is also an example. In some embodiments, a single piece of logic (and/or or several linked modules) may cause the computing device 130 to provide the described functionality.

As described below, detected weights from the weight sensors 310 and the weight sensors 311 may be utilized by the master controller 106 to verify the operation of various components of the assembly line grow pod 100 and may change growing conditions for plant matter in the carts 104.

Referring collectively to FIGS. 1, 4, and 6, a flowchart is depicted for changing a nutrition recipe for plant matter to prepare the plant matter for harvest. At block 610, the type of plant matter in the cart 104 is identified. At block 612, data is received from the weight sensors 310, the distance sensor 330, and/or the camera 340. The received data may include a detected plant matter weight from the weight sensors 310, a detected plant matter height from the distance sensor 330, and a chlorophyll level from the camera 340. At block 614, a harvest time recipe based on the identified plant matter is retrieved. At block 616, the received data from the weight sensors 310, the distance sensor 330, and/or the camera 340 is compared with the retrieved harvest time recipe. In embodiments, the detected plant matter weight from the weight sensors 310 is compared with a plant matter weight of the harvest time recipe. The detected plant matter height from the distance sensor 330 may be compared to a plant matter height of the harvest time recipe. Similarly, the detected chlorophyll level from the camera 340 may be compared to a chlorophyll level of the harvest time recipe. If the received data (e.g., from the weight sensors 310, the distance sensor 330, and/or the camera 340) satisfies one or more parameters of the retrieved harvest time recipe, then at block 618, a nutrition recipe for the plant matter within the cart 104 is changed to prepare the plant matter for harvest. If the received data does not satisfy the one or more parameters of the retrieved harvest time recipe, then at block 620, a nutrition recipe for the plant matter is changed to facilitate additional plant growth.

In embodiments, the master controller 106 may perform any or all of the blocks 610-620. Furthermore, while described and depicted as being performed in a specific order, it should be understood that certain blocks 610-620 may be performed in any suitable order and may be performed simultaneously. As described above, if the plant matter within the cart 104 is ready for harvest, a nutrition recipe for the plant matter may be changed to prepare the plant matter for harvest. For example, the amount of water and/or nutrients provided by the watering system 107, the amount of light provided by the lighting system 206 (FIG. 2), and/or the amount of airflow provided by the airflow system 111 may be adjusted to maintain the plant matter at the current state of growth. If the plant matter within the cart 104 is not ready for harvest, then the nutrition recipe for the plant matter may be changed to facilitate additional plant growth. For example, the amount of water and/or nutrients provided by the watering system 107, the amount of light provided by the lighting system 206 (FIG. 2), and/or the amount of airflow provided by the airflow system 111 may be increased to facilitate additional plant growth.

Referring to FIGS. 1, 4, and 7, a flowchart for selectively directing a cart 104 to a harvester system is depicted. At block 710, the type of plant matter in the cart 104 is identified. At block 712, data is received from the weight sensors 310, the distance sensor 330, and/or the camera 340. The received data may include a detected plant matter weight from the weight sensors 310, a detected plant matter height from the distance sensor 330, and a chlorophyll level from the camera 340. At block 714, a harvest time recipe based on the identified plant matter is retrieved. At block 716, the received data from the weight sensors 310, the distance sensor 330, and/or the camera 340 is compared with the retrieved harvest time recipe. In embodiments, the detected plant matter weight from the weight sensors 310 is compared with a plant matter weight of the harvest time recipe. The detected plant matter height from the distance sensor 330 may be compared to a plant matter height of the harvest time recipe. Similarly, the detected chlorophyll level from the camera 340 may be compared to a chlorophyll level of the harvest time recipe. If the received data (e.g., from the weight sensors 310, the distance sensor 330, and/or the camera 340) satisfies the one or more parameters of the retrieved harvest time recipe, then at block 718, the cart 104 is directed to the harvester system 208 (FIG. 2) so the plant matter within the cart 104 may be harvested. If the received data does not satisfy the one or more parameters of the retrieved harvest time recipe, then at block 720, the cart 104 is directed away from the harvester system 208 (FIG. 2). The cart 104 may additionally be directed on another lap of the assembly line grow pod 100 (e.g., up the ascending portion 102a and down the descending portion 102b) at block 720, which may allow for additional plant growth for the plant matter on the cart 104.

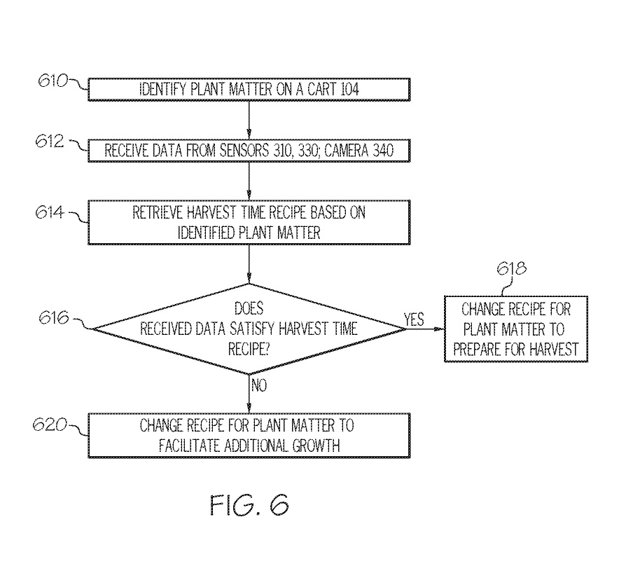

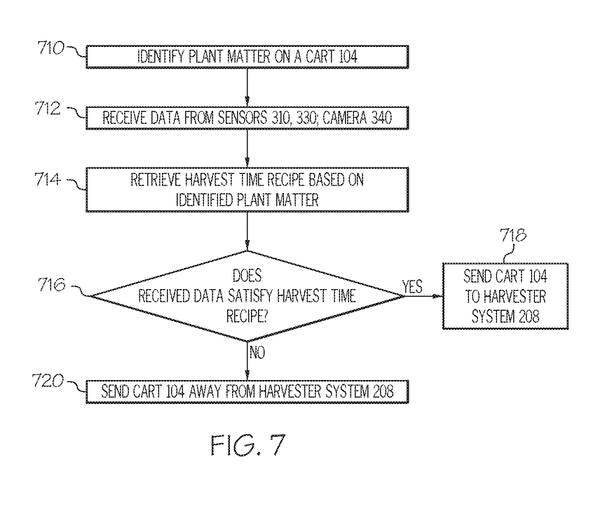

In embodiments, the master controller 106 may perform any or all of the blocks 710-720. Furthermore, while described and depicted as being performed in a specific order, it should be understood that certain blocks 710-720 may be performed in any suitable order and may be performed simultaneously. As described above, if the plant matter within the cart 104 is ready for harvest, the cart 104 may be directed to the harvester system 208 (FIG. 2). If the plant matter within the cart 104 is not ready for harvest, then the cart 104 may be directed away from the harvester system 208 (FIG. 2) to take another lap on the assembly line grow pod 100 to allow additional plant growth for the plant matter in the cart 104. It should be understood that the blocks 710-720 depicted in FIG. 7 may be performed alone or may be simultaneously performed with other processes, such as the blocks 610-620 depicted in FIG. 6. In some embodiments, the blocks 710-720 may be performed based on a detected position of the cart 104 within the assembly line grow pod 100, such as from the position sensor 315 on the cart 104. For example, the blocks 710-720 may be performed upon detecting that the cart 104 is within a predetermined distance of the harvesting region 209 (FIG. 2) and/or is at the bottom of the descending portion 102b of the assembly line grow pod 100. In this way, the cart 104 may be diverted away from the harvesting region 209 (FIG. 2) and the harvester system 208 (FIG. 2) upon detecting that the plant matter does not satisfy one or more of the harvest time recipe parameters.

As illustrated above, various embodiments for determining harvest timing for plant matter within a grow pod are disclosed. In particular, characteristics of plant matter within individual carts may be detected and compared with a harvest timing recipe. Based on the comparison, the cart may be directed to a harvesting system or may be directed to continue growing the plant matter on the cart. Further, in some embodiments, a nutrition recipe including water and/or nutrients provided to the plant matter on the cart may be changed to facilitate additional plant growth or maintain a present level of plant growth. In this way, the decision of when harvesting is appropriate for plant matter may made at the cart level, as opposed to harvesting decisions made with respect to an entire crop. By making harvesting decisions at the cart level, crop yield may be increased by ensuring that plant matter is not harvested until an appropriate growth level has been attained for each cart.

While particular embodiments and aspects of the present disclosure have been illustrated and described herein, various other changes and modifications can be made without departing from the spirit and scope of the disclosure. Moreover, although various aspects have been described herein, such aspects need not be utilized in combination. Accordingly, it is therefore intended that the appended claims cover all such changes and modifications that are within the scope of the embodiments shown and described herein.

It should now be understood that embodiments disclosed herein includes systems, methods, and non-transitory computer-readable mediums for determining a harvest time for a grow pod. It should also be understood that these embodiments are merely exemplary and are not intended to limit the scope of this disclosure.

What is claimed is:

1. An assembly line grow pod system comprising:
a track;
a cart for holding plant matter, the cart engaged with the track;
a harvester system positioned at least partially on the track;
at least one of:
a weight sensor positioned on the cart or the track; or
a distance sensor; and
a controller communicatively coupled to the at least one of the weight sensor or the distance sensor, the controller comprising a processor and a computer readable and executable instruction set, which when executed, causes the processor to:
identify a type of the plant matter positioned within the cart;
receive data indicative of at least one of a detected plant matter weight from the weight sensor and a detected plant matter height from the distance sensor;
retrieve a harvest time recipe based on the identified type of plant matter, the harvest time recipe comprising a harvest time plant matter weight and a harvest time plant matter height;
determine that the at least one of the detected plant matter weight and the detected plant matter height satisfies the harvest time plant matter weight and the harvest time plant matter height; and
in response to determining that the at least one of the at least one of the detected plant matter weight and the detected plant matter height satisfies the harvest time plant matter weight and the harvest time plant matter height, direct the cart to the harvester system.

2. The assembly line grow pod system of claim 1, wherein the executable instruction set, when executed, further causes the processor to, in response to determining that the at least one of the at least one of the detected plant matter weight and the detected plant matter height do not satisfy the harvest time plant matter weight and the harvest time plant matter height, direct the cart away from the harvester system.

3. The assembly line grow pod system of claim 2, wherein the track comprises an ascending portion that moves upward in a vertical direction, and wherein the executable instruction set, when executed, causes the processor to direct the cart away from the harvester system and further causes the processor to direct the cart to the ascending portion of the track.

4. The assembly line grow pod system of claim 1, further comprising a watering system communicatively coupled to the controller, and wherein the executable instruction set, when executed, further causes the processor to, in response to determining that the at least one of the detected plant matter weight and the detected plant matter height do not satisfy the harvest time plant matter weight and the harvest time plant matter height, change a nutrition recipe to be provided to the plant matter by the watering system.

5. The assembly line grow pod system of claim 1, further comprising a camera communicatively coupled to the controller, and wherein:
the harvest time recipe further comprises a harvest time plant matter chlorophyll level; and
the executable instruction set, when executed, further causes the processor to:
receive data indicative of a detected chlorophyll level of the plant matter within the cart from the camera;
determine that the detected chlorophyll level and the at least one of the detected plant matter weight and the detected plant matter height satisfies the harvest time plant matter weight, the harvest time plant matter height, and the harvest time plant matter chlorophyll level; and
in response to determining that the detected chlorophyll level and the at least one of the detected plant matter weight and the detected plant matter height satisfies the harvest time plant matter weight, the harvest time plant matter height, and the harvest time plant matter chlorophyll level, direct the cart to the harvester system.

6. The assembly line grow pod system of claim 1, further comprising a position sensor positioned on the cart and communicatively coupled to the controller, and wherein the executable instruction set, when executed, further causes the processor to:
detect a position of the cart with the position sensor;
determine whether the detected position of the cart is within a predetermined distance of the harvester system; and
receive the data indicative of the at least one of the detected plant matter weight from the weight sensor and the detected plant matter height from the distance sensor in response determining that the detected position of the cart is within the predetermined distance of the harvester system,

7. The assembly line grow pod system of claim 1, further comprising an environmental sensor positioned on the cart and communicatively coupled to the controller, and wherein the executable instruction set, when executed, further causes the processor to:
receive data indicative of a water level in the cart from the environmental sensor; and
receive the data indicative of the detected plant matter weight from the weight sensor and the environmental sensor.

8. A method for determining harvest timing for a cart within an assembly line grow pod, the method comprising:
identifying a type of plant matter positioned within the cart;
detecting at least one of a plant matter weight of the plant matter, a plant matter height of the plant matter, and a chlorophyll level of the plant matter;
determining that the at least one of the detected plant matter weight, the detected plant matter height, and the detected chlorophyll level satisfies a harvest time plant matter weight, a harvest time plant matter height, and a harvest time plant matter chlorophyll level; and
in response to determining that the detected plant matter weight, the detected plant matter height, and the detected chlorophyll level satisfy the harvest time plant matter weight, the harvest time plant matter height, and the harvest time plant matter chlorophyll level, directing the cart to a harvester system.

9. The method of claim 8, further comprising, in response to determining that the at least one of the detected plant matter weight, the detected plant matter height, and the detected chlorophyll level do not satisfy the harvest time plant matter weight, the harvest time plant matter height, and the harvest time plant matter chlorophyll level, directing the cart away from the harvester system.

10. The method of claim 9, wherein directing the cart away from the harvester system comprises directing the cart to an ascending portion of the assembly line grow pod.

11. The method of claim 9, further comprising removing the plant matter from the cart at the harvester system by moving an actuator to an extended position, causing at least a portion of the cart to tilt in a vertical direction.

12. The method of claim 11, wherein the actuator is positioned on the cart and moving the actuator to the extended position comprises rotating the portion of the cart about the actuator.

13. The method of claim 9, further comprising detecting whether the cart is positioned within a predetermined distance of a harvesting region, and wherein the detecting the at least one of the plant matter weight, the plant matter height, and the chlorophyll level of the plant matter is in response to detecting that the cart is positioned within the predetermined distance of the harvesting region.

14. The method of claim 9, wherein detecting the plant matter weight comprises detecting a level of water within the cart with an environmental sensor.

15. An assembly line grow pod system comprising:
a track;
a cart for holding plant matter, the cart engaged with the track;
an actuator positioned on one of the track or the cart;
at least one of:
a weight sensor positioned on the cart or the track; and
a distance sensor; and
a controller communicatively coupled to the actuator and the at least one of the weight sensor and the distance sensor, the controller comprising a processor and a computer readable and executable instruction set, which when executed, causes the processor to:
identify a type of the plant matter positioned within the cart;
receive data indicative of at least one of a detected plant matter weight from the weight sensor and a detected plant matter height from the distance sensor;
retrieve a harvest time recipe based on the identified type of plant matter, the harvest time recipe comprising a harvest time plant matter weight and a harvest time plant matter height;
determine that the at least one of the detected plant matter weight and the detected plant matter height satisfies the harvest time plant matter weight and the harvest time plant matter height; and
in response to determining that the at least one of the detected plant matter weight and the detected plant matter weight satisfies the harvest time plant matter weight and the harvest time plant matter height, move the actuator to an extended position to tilt at least a portion of the cart in a vertical direction.

16. The assembly line grow pod system of claim 15, wherein the track comprises an ascending portion, and wherein the executable instruction set, when executed, further causes the processor to, in response to determining that the at least one of the at least one of the detected plant matter weight and the detected plant matter weight do not satisfy the harvest time plant matter weight and the harvest time plant matter height, direct the cart to the ascending portion of the track.

17. The assembly line grow pod system of claim 15, further comprising a watering system communicatively coupled to the controller, and wherein the executable instruction set, when executed, further causes the processor to, in response to determining that the at least one of the at least one of the detected plant matter weight and the detected plant matter height do not satisfy the harvest time plant matter weight and the harvest time plant matter height, change a nutrition recipe to be provided to the plant matter by the watering system.

18. The assembly line grow pod system of claim 15, further comprising a position sensor positioned on the cart and communicatively coupled to the controller, wherein the executable instruction set, when executed, further causes the processor to:
detect a position of the cart with the position sensor;
determine that the detected position of the cart is within a predetermined distance of a harvesting region; and
receive the data indicative of the at least one of the detected plant matter weight from the weight sensor and the detected plant matter height from the distance sensor in response to determining that the detected position of the cart is within the predetermined distance of the harvesting region.

19. The assembly line grow pod system of claim 15, further comprising an environmental sensor positioned on the cart and communicatively coupled to the controller, and wherein the executable instruction set, when executed, further causes the processor to:
receive data indicative of a water level in the cart from the environmental sensor; and
receive the data indicative of the detected plant matter weight from the weight sensor and the environmental sensor.

20. The assembly line grow pod system of claim 15, further comprising a camera communicatively coupled to the controller, and wherein:
the harvest time recipe further comprises a harvest time plant matter chlorophyll level; and
the executable instruction set, when executed, further causes the processor to:
receive data indicative of a detected chlorophyll level of the plant matter within the cart from the camera;
determine that the detected chlorophyll level and the at least one of the detected plant matter weight and the detected plant matter height satisfies the harvest time plant matter weight, the harvest time plant matter height, and the harvest time plant matter chlorophyll level; and
in response to determining that the detected chlorophyll level and the at least one of the detected plant matter weight and the detected plant matter weight satisfies the harvest time plant matter weight, the harvest time plant matter height, and the harvest time plant matter chlorophyll level, move the actuator to the extended position to tilt the portion of the cart in the vertical direction.
